(19) United States
(12) Patent Application Publication
(10) Pub. No.: US 2016/0283092 A1
(43) Pub. Date: Sep. 29, 2016

(54) METHOD AND SYSTEM FOR GENERATING PERSONALIZED IMAGES FOR CATEGORIZING CONTENT

(71) Applicant: Google Inc., Mountain View, CA (US)

(72) Inventors: Dmitry Broyde, San Jose, CA (US); Konstantin Shtoyk, San Carlos, CA (US); Vijnan Shastri, Palo Alto, CA (US); Adam Jonathan Zarek, Toronto (CA)

(21) Appl. No.: 14/666,878

(22) Filed: Mar. 24, 2015

(51) Int. Cl. G06F 3/0484

(52) U.S. Cl. CPC G06F 3/04847; G06F 3/04842

(57) ABSTRACT

The present disclosure relates to a method and system for providing personalized images for interfaced objects in a user interface. The method includes receiving information regarding a user and analyzing the information to generate content suggestions for the user. Accordingly, the method may include obtaining media associated with the content suggestions and combining the media to generate a personalized image for least one interface object displayed in a user interface. The method may then transmit the personalized image to a client device to be embedded as an interface object in the user interface.

### BACKGROUND

User interfaces typically provide content recommendations to a user via a user interface in one of two ways. First, content recommendations may be provided as additional visual objects every time a user accesses the user interface. However, this approach can overwhelm the user or become intrusive. Alternatively, content recommendations may be provided through a series of complex menu options, thereby making the content recommendations difficult to access.

### BRIEF SUMMARY

One aspect of the disclosure provides a method for generating personalized images for interface objects in a user interface that includes receiving information regarding a user and analyzing the information to generate content suggestions for the user. Analyzing the information may include evaluating demographic information viewing history, listening history, recording history, content rental history, or content purchase history. The method may include obtaining media, such as poster art, cover art, video clips, and trailers, associated with the content suggestions and combining the media to generate a personalized image for each of the plurality interface objects. The method may then transmit the personalized image to a client device to be embedded as an interface object in an interface objects in the user interface. According to some examples, the user interface may be for a user of video service.

In some examples, the method may generate a personalized image for each of the plurality of interface objects in the user interface. In this regard, the plurality of interface objects may relate to a plurality of genres, such as comedy, drama, home and garden, documentary, horror, kids and family, sports, and action.

In other examples, combining the media to generate the personalized image may include stitching together a plurality of images associated with the content suggestions or creating an animation from the obtained media.

According to another aspect of the disclosure describes a system for generating personalized images for interface objects in a user interface. The system may include a memory to store media associated with content and a processor coupled to the memory. The processor may be configured to receive and analyze information regarding a user to generate content suggestions for the user. Analyzing the information may include evaluating demographic information, viewing history, listening history, recording history, content rental history, or content purchase history. Additionally, the processor may be configured to obtain media, such as poster art, cover art, video clips, and trailers, associated with the content suggestions from the memory and combine the obtained media to generate a personalized image for an interface object of a user interface. The processor may be configured to transmit the personalized image to a client device to be embedded as an interface object in a user interface.

According to some examples, the processor may be configured to generate a personalized image for each of the plurality of interface objects in the user interface.

In some examples, the plurality of interface objects may include a plurality of genres, such as comedy, drama, home and garden, documentary, horror, kids and family, sports, and action.

Other examples generate the personalized image by stitching together a plurality of images associated with the content suggestions or creating an animation from the obtained media.

Another aspect of the disclosure provides a method for displaying personalized images as interface objects in a user interface. The method may include transmitting user information to a content server and receiving personalized image data from the content server based on the user information. The personalized image data may correspond to an interface object of the user interface. The method may include embedding the personalized image data in an interface objects and displaying on a client device the user interface with the interface object having the embedded personalized image data.

Another aspect of the disclosure provides a system for displaying personalized images as interface objects in a user interface. The system may include a memory and a processor. The processor may be configured to transmit user information to a content server and receive personalized image data from the content server based on the user information. The personalized image data may correspond to an interface object of the user interface. The method may embed the personalized image data in an interface objects and display, on a client device, the user interface with the interface object having the embedded personalized image data.

### BRIEF DESCRIPTION OF THE DRAWINGS

FIG. 1 shows a system according to one example of the disclosure;

FIG. 2 shows the interaction between a client device and a server according to another example of the disclosure;

FIG. 3 illustrates a flowchart according to one aspect of the disclosure;

FIGS. 4A-4C show generating a personalized image according to one example of the disclosure;

FIG. 5 illustrates a flowchart according to another example of the disclosure; and

FIG. 6 shows an example of a user interface according to an example of the disclosure.

### DETAILED DESCRIPTION

In order to provide content recommendations to an end user, the system includes a client device and a content server. The client device may be a set-top box, a television, a smart TV, a personal computer, a mobile device, a smart phone, a tablet, or any type of computing device that includes a module for obtaining information regarding a user. The user information may include demographic information, the user's viewing history, recording history, content rental history, content purchase history, etc. The client device collects this information and transmits it to the content server.

The content server may be any type of content providing service, such as SageTV™, a cable or satellite television provider, a streaming video service, a streaming audio service, etc. The content server analyzes the information received from the client device to generate content suggestions for a variety of categories. The variety of categories may include genres, movies, TV shows, network shows, rentals, etc. Each category may have further subcategories. For example, the genre category may display subcategories, such as comedy, drama, home and garden, documentary, horror, kids and family, sports, and action, in a content recommendation interface. Alternatively, the TV show category may display subcategories corresponding to network channels (e.g. NBC, ABC, CBS, FOX, etc.).

After the content suggestions are generated, the content server obtains media associated with the recommendations. This media may include images, such as poster art or cover art, or video, such as clips or trailers. The content server combines the media to generate a personalized image for the interface objects associated with the variety of categories and subcategories described above. In this regard, combining the media could include stitching together images or video clips or creating an animation to display the media. Thus, the interface objects associated with the categories and subcategories include personalized image content that corresponds to the content server's recommendations for the user such that each user has an individualized interface object. That is, User A's interface object for the subcategory comedy (under the genre category) may be different than User B's interface object for the subcategory comedy.

The content server then transmits the personalized image for each of the interface objects to the client device. Each of the personalized images may include an identifier indicating which category with which to associate the interface object.

The client device receives the personalized image for at least one of a plurality of interface objects. The interface objects may include icons, buttons, and other articles displayed in the user interface, each object being associated with a particular category or subcategory. For instance, a plurality of interface objects associated with a category such as genre of movies, music, or television shows may include buttons corresponding to subcategories such as horror, drama, action, etc. As another example, each of the plurality of interface objects may correspond to a particular television network, such as CBS, NBC, FOX, etc. The client device takes the personalized image and embeds each of the personalized images in the interface object. The client device then displays the user interface with the personalized image data for each of the user interface objects.

The above-described features provide a user interface that seamlessly integrates recommended content into user interface objects. That is, the recommendations are included in the categories associated with the interface object. Thus, users do not need to learn new access patterns to obtain content recommendations. Moreover, displaying the personalized images for each interface content provides useful information that will accelerate users' searching for interesting content without adding visual complexity to the user interface.

In situations in which the systems discussed herein collect personal information about users, or may make use of personal information, the users may be provided with an opportunity to control whether programs or features collect user information (e.g., viewing habits, listening habits, information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

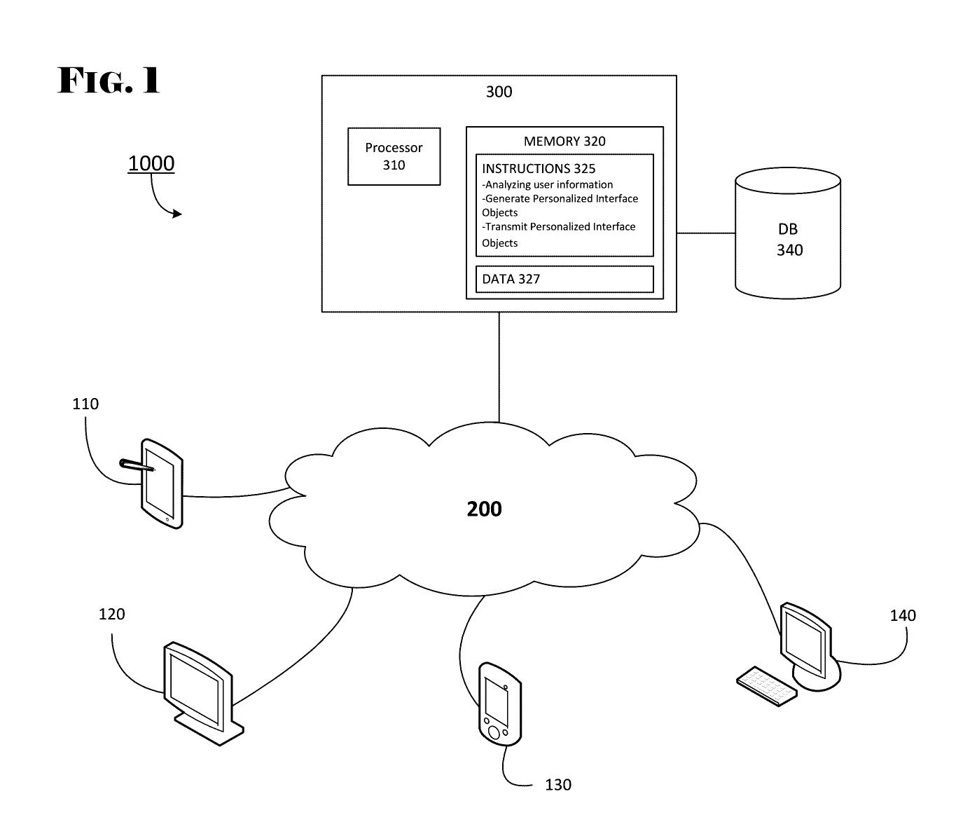

FIG. 1 shows a system 1000 that includes a tablet 110, a television 120, a portable device 130, a computer 140, a network 200, a server 300 and a media database 340.

The tablet 110 may be a tablet computing device capable of receiving and outputting content. In some examples, the tablet 110 may include an app that provides an interface for accessing the server. Similarly, the television 120 may be any type of display device capable of receiving and outputting content. In some examples, the television 120 may include a set-top box (not shown) capable of decoding the received content. The set-top box may output the content to television 120 for reproduction. Alternatively, the television 120 may be a “smart TV” (e.g., a television or set-top box integrated with the Internet and Web 2.0 features, such as social networking sites, blogs, wikis, video sharing sites, hosted services, and web applications).

The portable device 130 may include a smart phone, cellular phone, phablet, or any other device capable of receiving and reproducing content. The portable device 130 may also have an app that is capable of accessing the server 300. The computer 140 may include any suitable computing device, such as a desktop computer or a laptop computer. In this regard, the tablet 110, the television 120, the portable device 130, and the computer 140 may be capable of receiving content from server 300 via network 200.

The network 200 may comprise various configurations and use various protocols including the Internet, World Wide Web, intranets, virtual private networks, a cable network, a coaxial cable network, a television network, a satellite network, local Ethernet networks, private networks using communication protocols proprietary to one or more companies, cellular and wireless networks (e.g., WiFi), data center networks, and various combinations of the foregoing.

The server 300 may include a processor 310 and memory 320. The server 300 may be any type of computing device capable of providing content to a plurality of computing devices. The server 300 may be a cluster of computing devices located in a server farm or a data center. The server 300 may be a content server capable of content, such as SageTV™ or a cable or satellite provider.

The processor 310 may be any conventional processor, such as processors from Intel Corporation or Advanced Micro Devices. Alternatively, the processor 310 may be a dedicated controller such as an application specific integrated circuit (ASIC), field programmable gate array (FPGA), etc. Additionally, the processor 310 may include multiple processors, multi-core processors, or a combination thereof. Accordingly, references to a processor will be understood to include references to a collection of processors or dedicated logic that may or may not operate in parallel.

The memory 320 may be any memory capable of storing information accessible by the processor 310, including instructions 325 and data 327, that may be executed or otherwise used by the processor. In this regard, the memory 320 may be of any type capable of storing information accessible by the processor, including a computer-readable medium, or other medium that stores data that may be read with the aid of an electronic device, such as a hard-drive, memory card, flash drive, ROM, RAM, DRAM, DVD or other optical disks, as well as other write-capable and read-only memories. In that regard, memory may include short term or temporary storage as well as long term or persistent storage. Alternatively, the memory 320 may include a storage area network (SAN) capable of being accessed by server 300. Systems and methods may include different combinations of the foregoing, whereby different portions of the instructions and data may be stored on different types of media.

The instructions 325 may be any set of instructions to be executed directly (such as machine code) or indirectly (such as scripts) by the processor 310. For example, the instructions may be stored as computer code on the computer-readable medium. In that regard, the terms “instructions,” “modules,” and “programs” may be used interchangeably herein. The instructions may be stored in object code format for direct processing by the processor, or in any other computer language including scripts or collections of independent source code modules that are interpreted on demand or compiled in advance. The instructions may be executed to, for example, analyze user information, generate content recommendations based on the user information, obtain media content related to the content recommendations, generate a personalized image based on the obtained media content, etc. Functions, methods and routines of the instructions are explained in more detail below.

The data 327 may be retrieved, stored or modified by processor 310 in accordance with the instructions 325. For instance, although the system and method are not limited by any particular data structure, the data may be stored in computer registers, in a relational database as a table having a plurality of different fields and records, XML documents or flat files. The data may also be formatted in any computer-readable format. The data may comprise any information sufficient to identify the relevant information, such as numbers, descriptive text, proprietary codes, references to data stored in other areas of the same memory or different memories (including other network locations) or information that is used by a function to calculate the relevant data. The data may include, for example, content, such as audio, video, images, gifs, vines, etc., and artwork associated with the content.

The database 340 may be any database format capable of storing content, such as audio, video, images, gifs, vines, etc., and artwork associated with the content, for example cover art, movie posters, movie trailers, etc. That is, the database 340 may be any database capable of being indexed, queried, and/or searched. Alternatively, the database 340 may be a table or a data array capable of being indexed, queried, and/or searched.

The database 340 may be located at a third party, separate from the server 300. For example, the database 340 may include a plurality of storage devices accessible by the server 300 via a SAN. Alternatively, the first database 340 may be local to the server 300. For example, the first database may be stored in the memory 320.

In operation, the tablet 110, the television 120, the portable device 130, and the computer 140 may register with a content provider located at server 300. During the registration process, a user may optionally provide user information, such as demographic information. The registration process may include signing-up with a service provider, such as a cable television provider. Alternatively, the registration process may include downloading, installing, and creating a profile for an app that provides streaming content. In yet another example, the registration process may include creating a profile on a television network's website to obtain content provided by the television network. One of ordinary skill would recognize that the registration process may include any combination of the foregoing. For example, signing-up with a service provider may provide access to content via an app and a website. The registration process may better serve the client device by selecting more accurate content recommendations.

After the registration process is complete, the user may obtain content from the server 300. Content may include audio, video, images, gifs, vines, etc. Accordingly, the server 300 may provide content to the tablet 100, the television 120, the portable device 130, and the computer 140. Providing content may include, for example, streaming audio, streaming video, cable television, satellite television, etc.

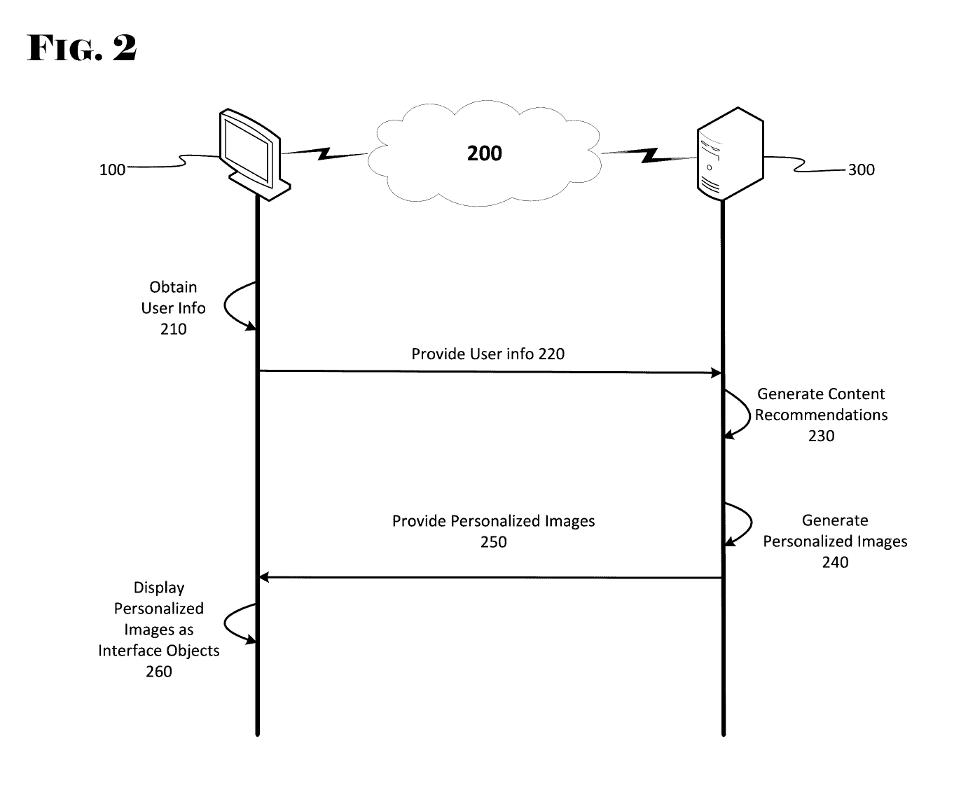

According to one example of the disclosure, the server may generate personalized images to be displayed as interface objects in a user interface based on generated content recommendations. FIG. 2 shows an example of the interaction between a client device and a server related to generating personalized images to be displayed as interface objects in a customized user interface.

FIG. 2 includes a client device 100, network 200, and a server 300. The client device 100 may include any computing device capable of transmitting user information, receiving content and displaying a user interface. Further, the client device 100 may be any type of computing device that includes a module for obtaining information regarding a user. Accordingly, client device 100 may include a tablet, a television, a portable device, or a computer as described above. The network 200 may be any type of network as described above. Similarly, the server 300 may be any server capable of providing content to the client device 100.

At 210 the client device 100 may obtain user information. As discussed above, the user information may include demographic information. Alternatively or additionally, the user information may include, for example, viewing history, listening history, recording history, content rental history, content purchase history, etc. The client device may collect the user information and provide the user information to server 300 in 220. In 230, the server 300 may generate content recommendations based on the user information provided by the client device. Based on the generated content recommendations, the server 300 may generate a personalized image in 240 that may be displayed as an interface object for the user interface displayed on client device 100. At 250, the server 300 provides the personalized images to the client device 100. At 260, the client device 100 embeds the personalized images as interface objects in a user interface and displays the personalized image as an interface object in the user interface thereby providing a customized interface that seamlessly integrates content recommendations into the user interface.

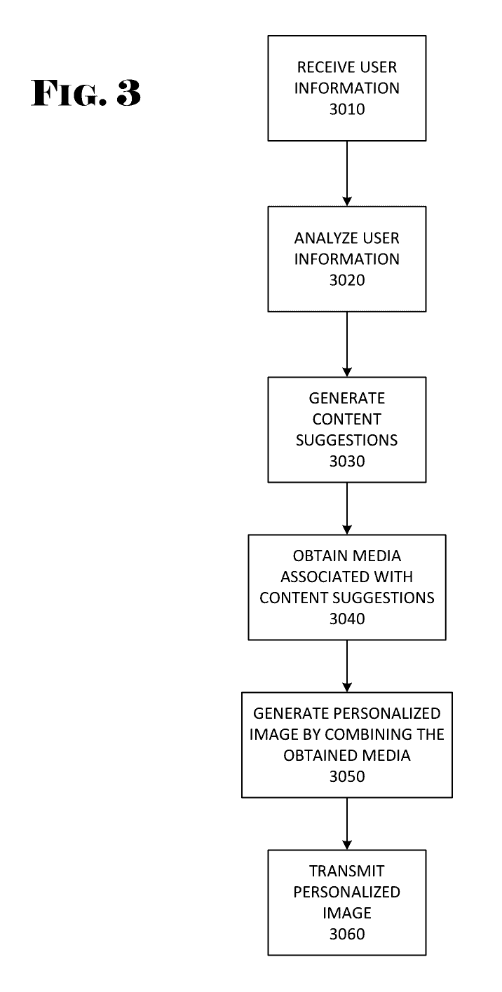

FIG. 3 illustrates a flow chart for generating a personalized image. In block 3010, a server receives user information. As discussed above, the user information may include demographic information, as well as viewing history, listening history, recording history, content rental history, and content purchase history. The client device may provide user information via electronic communication, such as an email, SMS, etc. Alternatively, the user information may be provided via a registration process as described above. In yet another example, the user information may be obtained by keeping a record of the viewing and/or listening habits of the client device, which may be provided to the server by the client device. The server may use the user information to provide more accurate content recommendations thereby enhancing the user's viewing and/or listening experience.

In block 3020, the server may analyze the user information received from the client device. That is, the server may use any combination of the user information to generate content suggestions in block 3030. The content suggestions may be for a variety of categories. The variety of categories may include genres, movies, TV shows, network shows, rentals, etc. Each category may have further subcategories. For example, the genre category may display subcategories, such as comedy, drama, home and garden, documentary, horror, kids and family, sports, and action, via a user interface. Alternatively, the TV show category may display subcategories corresponding to network channels (e.g. NBC, ABC, CBS, FOX, etc.). In some examples, the server may generate content recommendations for the subcategories.

After the content suggestions are generated, the server obtains media associated with the recommendations in block 3040. As discussed above, the server may obtain media from an external database or third-party. Alternatively, the media may be obtained from a memory local to the server. The obtained media may include images, such as poster art or cover art, or video, such as clips or trailers.

In block 3050, the server may combine the obtained media to generate a personalized image for the interface objects associated with the variety of categories and subcategories described above. In this regard, combining the media may include stitching images or video clips together. Alternatively, combining the media may include creating an animation to display the media. Accordingly, each of the interface objects associated with the categories and subcategories may include a personalized image that corresponds to the server's recommendations for the user thereby creating a customized user interface for each user. In this regard, providing a user interface that seamlessly integrates recommended content into interface objects of a user interface would enhance the user's viewing experience. For example, users would not need to learn new access patterns to obtain content recommendations. Furthermore, integrating content recommendations into the interface objects of a user interface may accelerate a user's search for interesting content without adding visual complexity to the user interface.

In block 3060, the server may transmit personalized images for each of the interface objects to the client device. Each of the personalized images may include an identifier indicating which category with which to associate the interface object.

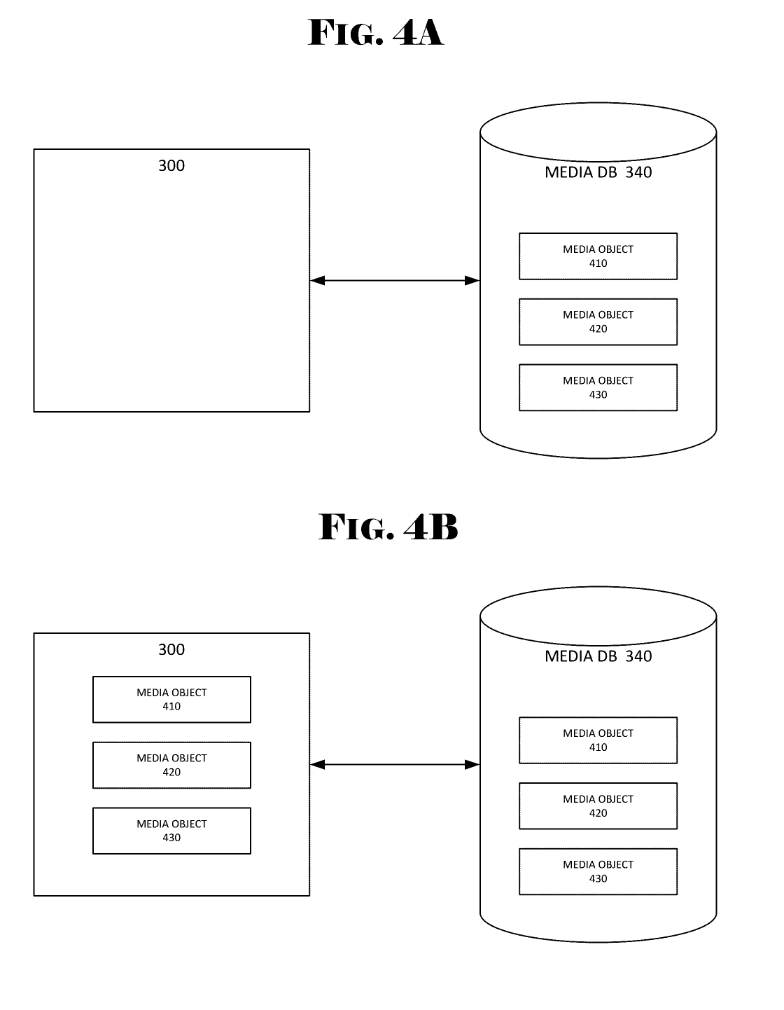

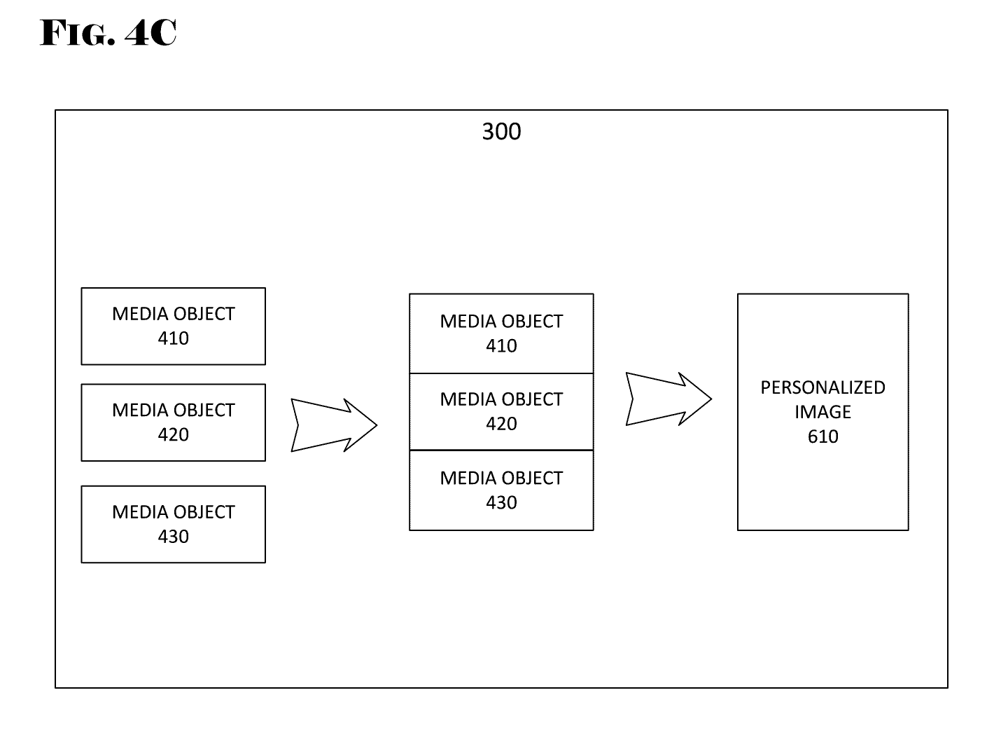

FIGS. 4A-4C illustrate an example of a server generating a personalized image. FIG. 4A includes a server 300 and media database 340. Media database 340 includes media object 410, media object 420, and media object 430. Media object 410, media object 420, and media object 430 may include images or videos. Images may include, for example, poster art or cover art. Video may include clips or trailers.

FIGS. 4A and 4B show server 300 accessing database 340 to obtain media associated with content recommendations generated by the server. In operation, the server 300 may generate content recommendations for the client device as described above. In this regard, media object 410, media object 420 and media object 430 may correspond, respectively, to a first content recommendation, a second content recommendation, and a third content recommendation generated by the server. Accordingly, media object 410, media object 420, media object 430 may be transferred from database 430 to server 300 where server 300 may combine the obtained media objects to create a personalized image.

For example, media object 410 may be a movie poster associated with a first content recommendation, media object 420 may be a teaser trailer associated with a second content recommendation, and media object 430 may be a movie poster associated with a third content recommendation. The server may retrieve media object 410, media object 420, and media object 430 from the database 340. Accordingly, the server may combine media object 410, media object 420, and media object 430 to form personalized image 610 as shown in FIG. 4C.

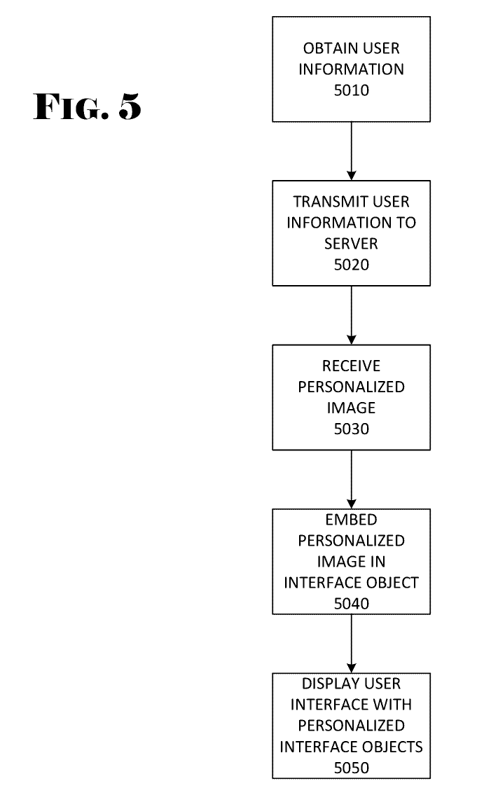

FIG. 5 illustrates a flowchart according to another example of the present disclosure. In block 5010, a client device obtains information from the user. As noted above, the obtained user information may include data gathered during a registration process or by keeping a record of the user's viewing and/or listening habits. In block 5020, the client device may transmit the user information to a server. In response to providing user information, the client device may receive a personalized image to be embedded in an interface object of a user interface. The personalized image may include an identifier that indicates which interface object the personalized object should be used with. In block 5040, the client device may embed the personalized image in its respective interface object. That is, the personalized image may be used as the interface object for one of the categories or subcategories discussed above. For example, the personalized image may be embedded under the “Comedy” category, thereby seamlessly integrating content recommendations in the user interface.

In block 5050, the client device displays the user interface with the personalized image being displayed as part of the interface object.

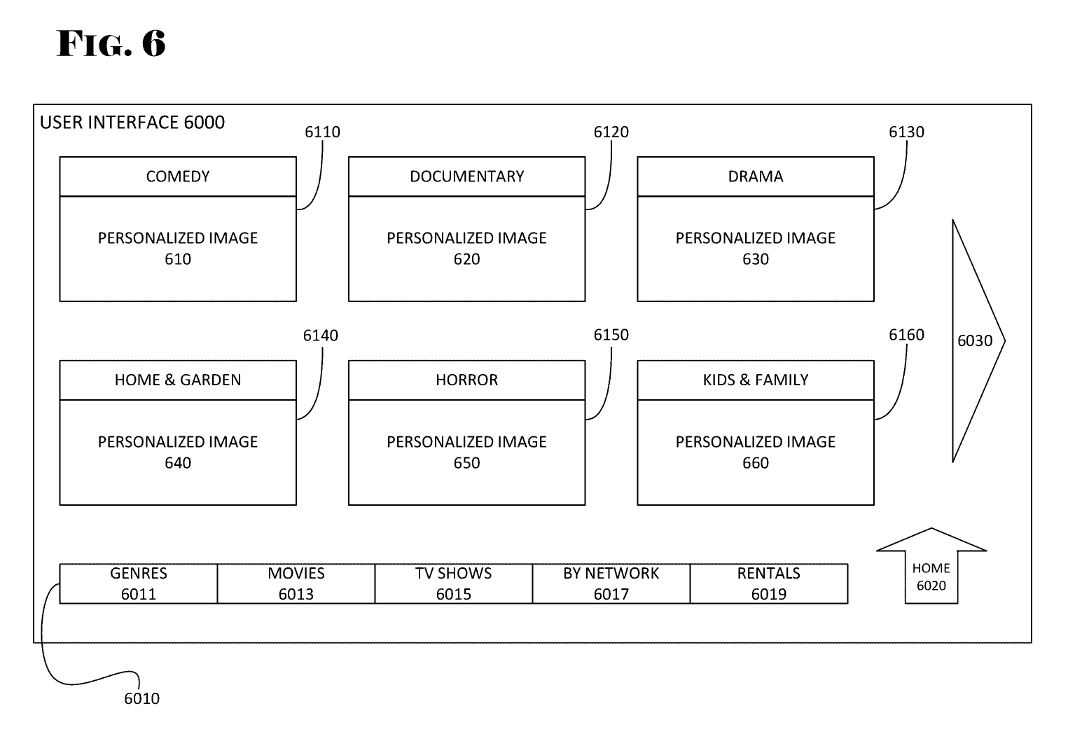

FIG. 6 illustrates an example of a user interface 6000 with personalized images being displayed as part of the interface object. The user interface 6000 includes a category interface object 6010, a home interface object 6020, and a scroll option interface object 6030. The home interface object 6020 may display a home screen when selected. The scroll option interface object 6030 may allow a user to scroll to more subcategories.

The category interface object 6010 may include a genres interface object 6011, a movie interface object 6013, a TV show interface object 6015, a network interface object 6017, and a rentals interface object 6019. The category interface object 6010 may include additional interface objects, such as a music interface object. Selection of one of the interface objects in the category interface object may display a plurality of subcategory interface objects. As shown in FIG. 6, selection of the genres interface object 6011 causes the user interface 6000 to display a plurality of subcategory interface objects, such as comedy interface object 6110, documentary interface object 6120, a drama interface object 6130, a home and garden interface object 6140, a horror interface object 6150, and a kids and family interface object 6160.

Selection of another interface object in the category interface object 6010 may provide a different set subcategories. For example, selection of the network interface object 6017 may cause the user interface 6000 to display a plurality of interface objects associated with network television channels, such as CBS, NBC, FOX, ABC, etc.

Returning to FIG. 6, the comedy interface object 6110, documentary interface object 6120, a drama interface object 6130, a home and garden interface object 6140, a horror interface object 6150, and a kids and family interface object 6160 each have a personalized image associated therewith. As noted above, the client device may embed the received personalized image in its corresponding interface object. For example, the personalized image 610 may include an identifier, such as metadata, a tag, etc., that indicates the personalized image 610 is to be associated with the comedy interface object 6110. Similarly, the personalized image 620 may include an identifier that indicates the personalized image 620 is to be associated with the comedy interface object 6120. Accordingly each of the personalized images 630, 640, 650, and 660 may include an indication that associates the personalized image with a respective interface object. After embedding the personalized images in their respective interface objects, the client device may display the user interface with the personalized images for each of the interface objects.

The above-described examples provide a user interface that seamlessly integrates recommended content into interface objects of a user interface. Thus, users do not need to learn new access patterns to obtain content recommendations. Moreover, displaying the personalized images for each interface content provides useful information that will accelerate users' searching for interesting content without adding visual complexity to the user interface.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for generating personalized images for interface objects in a user interface, comprising:
receiving, with one or more processors, information regarding a user;
analyzing, with the one or more processors, the information regarding the user;
generating, with the one or more processors, content suggestions for the user for a plurality of interface objects in a user interface;
obtaining, with the one or more processors, media associated with the content suggestions;
combining, with the one or more processors, the media to generate a personalized image for at least one of the plurality of interface objects;
transmitting the personalized image for the at least one of the plurality of interface objects to a client device to be embedded as an interface object in the plurality of interface objects in the user interface.

2. The method of claim 1, further comprising:
generating a personalized image for each of the plurality of interface objects in the user interface.

3. The method of claim 1, wherein analyzing the information further comprises evaluating one or more from the group consisting of: demographic information viewing history, listening history, recording history, content rental history, and content purchase history.

4. The method of claim 1, wherein the plurality of interface objects includes at least one of a plurality of genres.

5. The method of claim 4, wherein the genres are selected from the group consisting of: comedy, drama, home and garden, documentary, horror, kids and family, sports, and action.

6. The method of claim 1, wherein obtaining the media comprises selecting the media from a group comprising: poster art, cover art, video clips, and trailers.

7. The method of claim 1, wherein combining the media to generate the personalized image further comprises:
stitching together a plurality of images associated with the content suggestions.

8. The method of claim 1, wherein combining the media to generate the personalized image further comprises:
creating an animation from the obtained media.

9. The method of claim 1, wherein the user is a video service user.

10. A system for generating personalized images for interface objects in a user interface, comprising:
at least one memory to store media associated with content; and
one or more processors, communicatively coupled to the at least one memory, configured to:
receive information regarding a user;
analyze the information regarding the user;
generate content suggestions for the user for a plurality of interface objects in a user interface;
obtain media, from the at least one memory, associated with the content suggestions;
combine the media to generate a personalized image for at least one of the plurality of interface objects;
transmit the personalized image for the at least one of the plurality of interface objects to a client device to be embedded as an interface object in the plurality of interface objects in the user interface.

11. The system of claim 10, wherein the processor is further configured to:
generate a personalized image for each of the plurality of interface objects in the user interface.

12. The system of claim 10, wherein analyzing the information further comprises evaluating one or more from the group consisting of: demographic information, viewing history, listening history, recording history, content rental history, and content purchase history.

13. The system of claim 10, wherein the plurality of interface objects includes at least one of a plurality of genres.

14. The system of claim 13, wherein the genres are selected from the group consisting of: comedy, drama, home and garden, documentary, horror, kids and family, sports, and action.

15. The system of claim 10, wherein obtaining the media comprises selecting the media from a group comprising: poster art, cover art, video clips, and trailers.

16. The system of claim 10, wherein combining the media to generate the personalized image further comprises:
stitching together a plurality of images associated with the content suggestions.

17. The system of claim 10, wherein combining the media to generate the personalized image further comprises:
creating an animation from the obtained media.

18. The system of claim 10, wherein the user is a video service user.

19. A method for displaying personalized images as interface objects in a user interface, comprising:
transmitting, to a content server, information regarding a user;
receiving, from the content server, personalized image data for at least one of a plurality of interface objects based on the information regarding the user, each interface object corresponding to a subcategory within a given category;
embedding the personalized image data in at least one of the plurality of interface objects; and
displaying a user interface on the client device, the user interface including the at least one of the plurality of interface objects having the embedded personalized image data.

20. A system for displaying personalized images as interface objects in a user interface, comprising:
at least one memory; and
one or more processors, communicatively coupled to the at least one memory, configured to:
transmit information regarding a user;
receive personalized image data for at least one of a plurality of interface objects based on the information regarding the user, each interface object corresponding to a subcategory within a given category;
embed the personalized image data in at least one of the plurality of interface objects; and
display a user interface on the client device, the user interface including the at least one of the plurality of interface objects having the embedded personalized image data.
